(19) United States
(12) Patent Application Publication
(10) Pub. No.: US 2005/0244221 A1
(43) Pub. Date: Nov. 3, 2005

(54) Expandable frictional end disc

(76) Inventor: Regis John Seaman, Eustis, FL (US)

Correspondence Address: DARRIN S. RAMSEY, 476 SOUTHRIDGE INDUSTRIAL PARK, TAVARES, FL, 32778, US

(21) Appl. No.: 10/834,430

(22) Filed: Apr. 29, 2004

(51) Int. Cl. F16B 13/04

(52) U.S. Cl. 403/370

(57) ABSTRACT

A generally circular-shaped expandable end disc. The expandable frictional end disc has a plurality of slots. At least two control slots extend radially and substantially through the end disc. One through slot extends radially and entirely through the end disc. The through slot allows the end disc to expand and contract when a force is applied to or relieved from the expandable end disc. A method of securing an expandable frictional end disc inside of a finished or unfinished tube using an opposed-tapered locking device.

### BACKGROUND OF THE INVENTION

1. Field of the Invention

The invention generally relates to an expandable frictional end disc. More particularly, certain embodiments of the invention relate to the expansion of an expandable end disc that forms a frictional bond between the end disc and a tube and between the end disc and a shaft-locking device.

2. Description of the Relevant Art

Conveyor systems today are moving faster and carrying higher tonnage that ever before. Conveyors systems are designed to carry material over specific distances for many industries from farming, mining, industrial to baggage handling. Conveyor pulleys or rollers are an important component of the conveyor systems. There are many different types of conveyor pulleys, for example, standard duty pulleys (welded hub pulleys, wing pulleys, custom rolls, keyless shaft/hub locking device pulleys), heavy-duty pulleys, mine duty pulleys and engineered class pulleys.

The pulley or roller elements of conveyors are commonly composed of cylindrical tubes, shafts, hubs, end plates or end discs and shaft-locking devices such as bushings or tapered locks. The end plates are an integral component of the pulley. Primary functions of the end plates serve to transmit torque through the shaft to the pulley tube and to locate the position of the shaft to the pulley tube. Proper positioning of the shaft to the tube helps to eliminate or reduce imbalances and stress. Many conventional end plate installations weld the end plate to the tube. Tolerance effects from the welding can create an unbalanced and non-concentric pulley assembly.

Further, once the end plate is welded to the pulley tube, neither the end plate nor the tube can be removed without destroying both the end plate and tube. Generally, the component parts of welded pulley assemblies are non-reusable and/or non-replaceable. Reusable or replaceable end plates are particularly useful since they lend a great deal of versatility to equipment by enabling use of such equipment in a number of different positioning or interchangeable arrangements. Additionally, a reusable or replaceable end plate or disc can be repositioned to correct imbalance problems. Consequently, use of different size end plates or discs is economically advantageous to both the manufacturer and user.

An estimated 90% of premature conveyor pulley failures occur in the end plates; most of these at the hub to end plate weld. Broken pulleys are seldom successfully repaired. Rewelded pulley shells are predicted to regenerate repaired cracks and or propagate new breaks. These “band-aides” carry with them a huge liability of catastrophic failures. Consequently, broken pulleys can cost at least twice as much even without including the costs to refit shaft, bearings and belts.

Referring to FIG. 1, in a typical pulley arrangement (10), a hub (14) is welded to an end plate or disc (15), a bushing (11) is placed within the hub (14) forming a bushing/hub assembly. A shaft (16) is passed through the bushing (11) being careful to align a key (17) on the shaft with a key slot (13) on the bushing (11) and secured within the bushing/hub assembly by set screws (12). The shaft and hub assembly is placed inside a pulley or roller (18). In order to secure and mount the shaft and hub assembly within the pulley (18), the end disc (15) is welded to the pulley (18).

### SUMMARY OF THE INVENTION

In one embodiment, a generally circular-shaped expandable frictional end disc has a plurality of slots extending substantially and radially through the expandable disc. The expandable disc may be composed of a metallic or non-metallic material.

In one embodiment, a method of securing a metallic or nonmetallic expandable frictional end disc inside of a finished or unfinished tube. A shaft is inserted through a shaft-securing or locking device then an expandable disc is placed over the shaft-securing device, all of which are placed inside of a finished or unfinished tube. The securing or tightening of the shaft-securing device to the shaft exerts a force against the expandable disc causing the expandable disc to expand and form a seal between the expandable disc and tube, and a seal between the expandable disc and the shaft-securing device.

In one embodiment, a metallic or nonmetallic expandable frictional end disc comprises a generally circular-shaped expandable disc surrounding a shaft-securing device. The end disc may comprise at least three slots with at least one of the at least three slots extending entirely and radially through the expandable disc. Tightening the shaft-securing device to a shaft passing through the shaft-securing device expands the expandable disc.

In one embodiment, a metallic or nonmetallic expandable frictional end disc comprises a generally circular-shaped expandable disc having at least three slots wherein the disc is placed over an opposed-tapered lock. Tightening the opposed-tapered lock exerts a force against the disc causing it to expand.

In one embodiment, a metallic or nonmetallic expandable frictional end disc comprises a generally circular-shaped expandable disc measuring at least six millimeters in thickness having at least three slots extending substantially and radially through the expandable disc. The disc is in contact and surrounds the opposed-tapered lock and tightening the opposed-tapered lock causes the disc to expand.

In one embodiment, a method for attaching a metallic or nonmetallic expandable frictional end disc comprises inserting a shaft through a shaft-securing device, placing the expandable disc over the shaft-securing device and placing the shaft, the shaft-securing device and the expandable disc inside of a tube and tightening the shaft-securing device to the shaft causing the shaft-securing device to exert a force against the expandable disc thus expanding the expandable disc. Seals are formed between the expandable disc and tube, and between the expandable disc and the shaft-securing device.

Other embodiments and advantages of the invention will be apparent from the following description and the appended claims.

### BRIEF DESCRIPTION OF THE DRAWINGS

The invention will be explained in more detail based on the embodiment and application examples subsequently described and illustrated in the drawings.

FIG. 1 (Prior Art) shows a typical pulley arrangement.

FIG. 2 shows an isometric perspective view of one embodiment of the present invention.

FIG. 3 shows an exploded view perspective of the first embodiment example of the expandable frictional end disc of FIG. 2 and the interaction with other common pulley components.

FIG. 4 shows a longitudinal, cross-sectional perspective view of FIG. 3 assembled.

### DETAILED DESCRIPTION OF THE INVENTION

Identical reference symbols in the individual figures and illustrations of the drawings refer to equal or similar or equally or similarly effecting components. Based on the illustrations in the drawings also such features which do not have reference symbols, become evident independent on the fact if such features are subsequently described or not. On the other hand, also features which are included in the present description, but not visible or illustrated in the drawings are easily evident to the ordinary person skilled in the art.

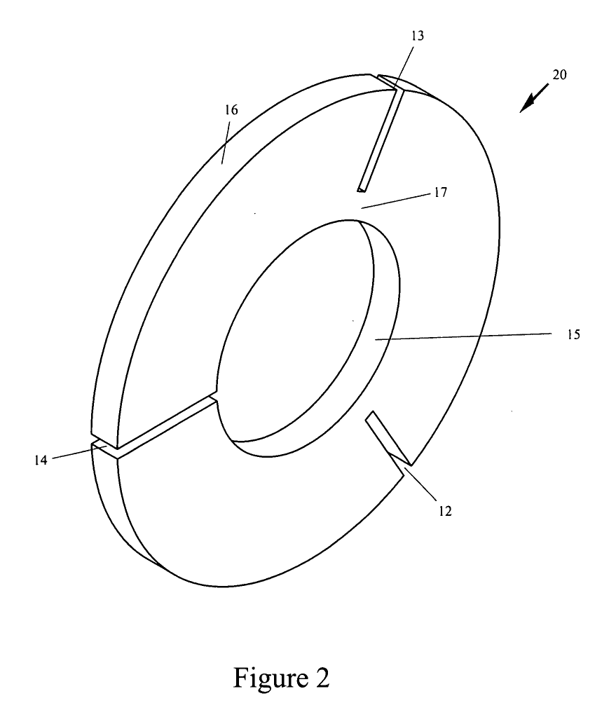

FIG. 2 shows an isometric perspective view of one embodiment of the present invention. With reference to the FIG. 2, from which further details and data can be taken, the following features, functions and advantages will be explained in detail only by example based on a first embodiment example. The expandable frictional end plate or disc 20 of the present invention is shown comprising a generally circular-shaped expandable end disc 20. The end disc 20 may be composed of a metallic substance such as aluminum, steel, stainless-steel or some other structural metal. It is further proposed that the disc can be manufactured from non-metallic materials; however, it is important that the non-metallic material possess structural integrity and other physical characteristics such as high tensile strength, high flexural modulus, and/or high section modulus that are substantially similar to structural metals.

As can be seen in FIG. 2, the expandable frictional end plate or disc 20 of the present invention is shown comprising a generally circular-shaped expandable end disc 20. The expandable frictional end disc 20 has a plurality of evenly spaced slots 12, 13 and 14. Control slots 12 and 13 extend radially and substantially through the end disc 20. Through slot 14 extends radially and entirely through the end disc 20. Through slot 14 allows the end disc 20 to expand and contract when a force is applied to or relieved from, respectively, the inside edge or surface 16 of the end disc 20. Slots 12, 13 and 14 are generally arranged as shown in FIG. 2.

The width of the through slot 14 is not critical since its purpose is to split the end disc 20 through its cross section. Preferably, the width of the through slot 14 should be kept to the minimum manufacturing tolerances to allow the greatest surface contact at the end disc 20-tube 34-shaft-securing device 30 interfaces. Through slot 14 will tend to open as a shaft-securing device 30 is torqued up.

The width of control slots 12 and 13 should only be wide enough to allow clearance for the elastic deformation occurring at assembly or torque up since the tendency at these locations will be toward closing. The depth of control slots 12 and 13 are determined by the bending moments about the resulting cross section 17 located at the bottom of each control slot 12 and 13. The end disc 20 must be flexible enough to apply the necessary pressure to a cylinder inner surface or pulley tube 36 within a set torque range. The range of dimensions can be found by various means such as traditional static curved beam calculations, finite element analysis or fabrication shop trial and error measurements.

Preferably, the end disc 20 is uniform in thickness. Thickness depends on application, tube size and/or torque requirements. Generally, in practice, thickness of the end disc 20 is determined by the cylinder or pulley tube diameter and design torque requirements. The torque acting over the moment about the center of rotation will determine the tangential force at the interface between component parts. The coefficient of friction between two components will determine the normal force. The resulting pressure distribution necessary to prevent a cylinder or pulley tube 34 from deforming will determine the thickness of the end disc 20 for a given application. Most applications require the end disc 20 to be manufacture to at least 6 mm thick.

One function of the expandable frictional end disc 20 is to transmit a uniformly distributed normal force or pressure from a shaft-securing device. This force is applied to the inner surface 16 of the end disc 20 from the shaft-securing device 30 and transmitted to the inner surface 36 of a cylinder or pulley tube 34. End disc 20 essentially behaves as a curved beam with opposing ends of the beam across the through slot 14. As pressure is applied to the inner surface 16, the beam or end disc 20 bends outward at the evenly spaced control slots 12, 13 where the cross-sectional moment is controlled by the slot depth. The pressure exerted on the inner surface 36 of a cylinder or pulley tube 34 is inversely proportional to the difference between the inner 16 and outer 15 diameters of the end disc 20 as long as the end disc 20 deformation is within the elastic limits of the end disc 20 material.

Torque is applied to a cylinder or pulley tube 34 through friction between the end disc 20 material and the tube 34 material as a tangential load is applied to the end disc 20 and resisted by the tube 34. The magnitude of the torque is controlled by the pressure applied and the contact surface area, which is directly proportional to the end disc 20 thickness. The end disc 20 thickness is calculated to transmit the required torque without deformation of the tube 34 by distributing the surface loading.

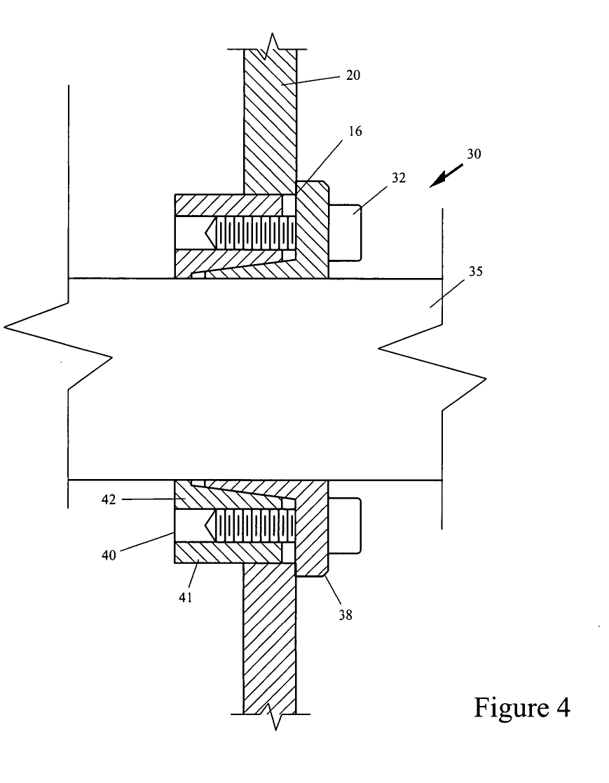

As seen in FIG. 4, the distributed load is accomplished through an opposed tapered locking device 30, which converts the tensile force on the tightened screws 32 through concentric conical sections (tapers) 38 and 40. The effect is equivalent to the mechanical advantage of an inclined plane or wedge where force in one direction has a normal resulting force.

The opposed tapered locking device 30 is also comprised of split rings which expand and contract respective to the direction of the opposing tapers 38, 40 causing the assembly to both grip a shaft 35 and apply the disc loading force described above.

The inside diameter and outside diameter of the expandable frictional end disc 20 are manufactured per application, depending on the inside and outside diameters of both the shaft and cylinder diameters. Preferably, the inside diameter of the end disc 20 should be designed to fit snugly on a locking assembly 30 while the outside diameter of the end disc 20 should be designed slightly smaller than the inside diameter of a cylinder or pulley tube 34.

The present invention can be manufactured to fit the entire range of cylinders, tubes and pulleys used in the multitude of industries that employ shaft-end plate components. Specifically, end disc 20 can be used with a variety of finished or unfinished tube 34 sizes. For example, the end disc 20 can be utilized with common pulley diameter ranges of 3 to 12 inches. However, the end disc 20 can also be manufactured to fit larger sized cylinders or pulley tubes 34.

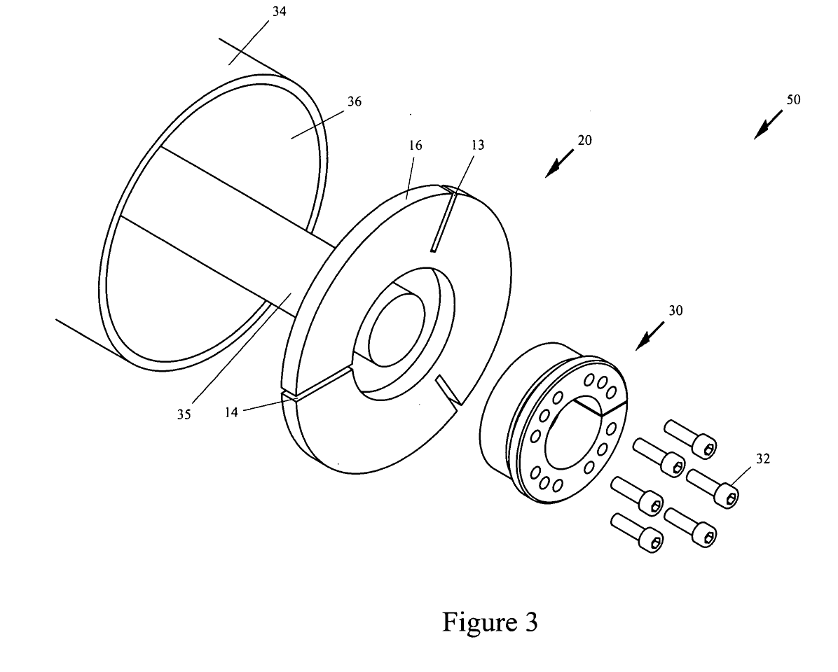

With reference to the FIG. 3, a process in accordance with an embodiment of the present invention is shown. In the embodiment in FIG. 3, a method for securing an end disc 20 to the inside diameter 36 of a finished or unfinished tube 34 using a shaft-securing device 30 is illustrated. The shaft-securing devices 30 utilized by the present invention are generally known in the art as shaft-hub locking devices, keyless frictional locking devices or locking assemblies. These devices are based on the inclined plane or taper principle. Clamping forces generated by the torque up of the locking devices are translated into predetermined contact pressures. For a comprehensive listing of typical locking assemblies or shaft-securing devices that may be used with the present invention, see Ringfeder Corporation of Westwood, N.J.

Shaft-securing devices 30 transmit torque and other loads by means of mechanical interference generated by pressure exerted on both the shaft and expandable frictional end disc 20. Given that torque is transmitted by contact pressure and friction between the frictional surfaces of the outer edge 15 of the expandable frictional end disc 20 and the inside diameter 36 of a finished or unfinished tube 34 and conjointly between the inner edge 16 of the expandable frictional end disc 20 and the outer surface 33 of the shaft-securing device 30, the condition of the contact surfaces and the proper tightening of the locking screws are important. Hence, before installation, all contact surfaces should be cleaned and lightly oiled. As FIG. 3 shows, a shaft-securing device 30 slides onto a shaft 35 and into an expandable frictional end disc 20. After placing the shaft 35, end disc 20 and shaft-securing device 30 within the finished or unfinished tube 34 and locating the proper position of the end disc 20 inside of the tube 34 (end disc's 20 diameter should be slightly smaller than the tube 34 opening), the locking screws 32 are gradually tightened in a diametrically opposite sequence until a proper torque value is obtained. Generally, only ¼ to ½ of the maximum torque transmitted by a shaft-securing device according to the manufactures specifications need be applied, otherwise the finished or unfinished tube 34 may yield. As the locking screws 32 are tightened, the torque gradually increases, and the shaft-securing device 30 begins to exert a force against the end disc 20, through slot 14 begins to expand while control slots 12 and 13 begin to deform.

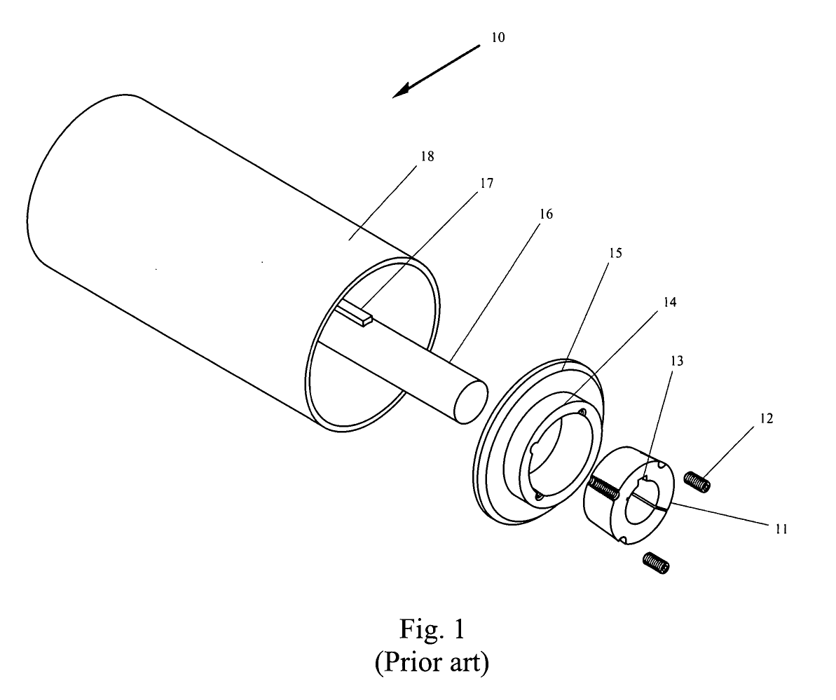

After proper positioning, centering and tightening, all of the assembled component can be unassembled without destruction of any one component. Each part capable of being reused or replaced. If one or more component part(s) should fail, only the damaged part or parts need be replaced. Frictional seals are formed between the contact surfaces of the expandable frictional end disc 20 and the shaft-securing device 30 and tube 34. Unlike the conventional method of welding an end plate 15 to a pulley 18 (or 34) and welding an end plate 15 to a hub 14, as shown in FIG. 1 (prior art), the present invention relies on the frictional bonds to form seals between the contact surfaces.

FIG. 4 shows a longitudinal, cross-sectional perspective view of FIG. 3 assembled, as a result showing an embodiment example of an opposed-tapered shaft-securing device 30, a shaft 35 and an expandable frictional end disc 20. The opposed-tapered shaft-securing device 30 is merely an example of the multitude of locking devices available in the frictional locking device industry. The shaft-securing device 30 may be a single taper design or a double taper design (not shown). This patent does not detail all of the different types of shaft-securing devices 30 available. However, the present invention is designed to be used with all opposed-tapered locking device designs. As further shown in FIG. 4, the shaft-securing device 30 surrounds the shaft 35 and the shaft-securing device 30 is in contact with the expandable frictional end disc 20. By tightening the lock screws 32, the tapered sleeve 40 is drawn closer to the tapered flange 38, thus tightening the tapered flange 38 down on the shaft 35 and exerting a radial or outward force on the expandable frictional end disc 20. The tapered flange 38 coupled with the inner tapered surface 42 forms a frictional seal with the shaft 35. The outer surface 41 forms a frictional seal with the inside edge 16 of the expandable frictional end disc 20.

By way of example, one embodiment of the present invention includes an end disc 20 of a generally circular-shaped measuring at least 6 millimeters thick with at least three slots 12, 13 and 14, for example as shown in FIGS. 2 and 3, extending substantially and radially through the generally circular-shaped expandable disc 20. The expandable frictional end disc 20 may be manufactured with less than or more than three slots depending on application. The shaft-securing device 30 has an opposed-tapered lock 40, one example in FIG. 4. The contact surfaces of the inside edge 16 of the generally circular-shaped expandable disc 20 and the outer edge 33 of the shaft-securing device 30 are in contact with minimal distance between the two contact surfaces. Preferably, a snug fit between the two component parts is desired to ensure maximum torque transmission from the opposed-tapered lock 40 to the end disc 20. Preferably, the end disc is slightly smaller in diameter than the finished or unfinished tube 34.

In addition, a method for attaching an expandable frictional end disc 20 is shown as an exploded view in FIG. 3. A shaft 35 is inserted through a shaft-securing device 30. An expandable frictional end disc 20 is placed on the outer edge 33 of the shaft-securing device 30. The inside diameter of the expandable frictional end disc 20 is slightly larger than the outer edge 33 of the shaft-securing device 30. The expandable frictional end disc 20 is slid on the shaft-securing device 30, thereby, forming a subassembly 50, which includes the shaft 35, the shaft-securing device 30 and the expandable frictional end disc 20. The subassembly 50 is placed inside of a finished or unfinished tube 34. In order to secure subassembly 50 inside of a cylinder or tube 34, lock screws 32 are gradually tightened in a diametrical opposite sequence referencing the manufactures standards and requirements to torque up the shaft-securing device 30 to a required torque of, for example, ¼, ⅓, ½ or more, depending on the specific requirements of the pulley tube 34 design and use. The force exerted by the shaft-securing device 30 on the inside surface 16 of the expandable frictional end disc 20 forms a frictional seal with the outside edge 33 of the shaft-securing device 30. The force exerted on the expandable frictional end disc 20 causes it to expand, thereby forming a frictional seal between the outer surface 15 of the expandable frictional end disc 20 and the inside surface 36 of the cylinder or tube 34. This process can be repeated for the opposite side of the tube 34 in conjunction with or after one side of a tube assembly is complete.

Similarly, sprockets have end disc, The expandable frictional end disc 20 of the present invention can also be a substitute for end plates found on sprockets, standard pulleys and engineered pulleys which are all common in the conveyor industry.

While the invention has been described with respect to a limited number of embodiments, those skilled in the art will appreciate that other embodiments can be devised which do not depart from the scope of the invention as disclosed herein. Accordingly, the scope of the invention should be limited only by the attached claims.

1. An end disc comprising,
a generally circular-shaped expandable disc having a plurality of slots extending substantially and radially through the expandable disc.

2. The end disc according to claim 1, wherein the plurality of slots comprise at least three slots with at least one of the at least three slots extending entirely and radially through the expandable disc.

3. The end disc according to claim 1, wherein the expandable disc is at least 6 mm thick.

4. The end disc according to claim 1, wherein the expandable disc is made from a metallic material.

5. The end disc according to claim 1, wherein the expandable disc can also be made from a non-metallic material.

6. A method for securing an end disc inside of a finished or unfinished tube using a shaft-securing device comprising,
(a) inserting a shaft through the shaft-securing device;
(b) placing an expandable disc over the shaft-securing device;
(c) placing the shaft, the shaft-securing device and the expandable disc inside of the finished or unfinished tube; and
(d) tightening the shaft-securing device to the shaft, wherein tightening the shaft-securing device exerts a force against the expandable disc causing the expandable disc to expand and form a frictional seal between the expandable disc and tube, and a frictional seal between the expandable disc and the shaft-securing device.

7. An end disc comprising,
(a) a generally circular-shaped expandable disc; and
(b) a shaft-securing device,
wherein the expandable disc surrounds the shaft-securing device.

8. The end disc according to claim 7, wherein the expandable disc comprises a plurality of slots extending substantially and radially through the expandable disc, wherein at least one of the at least three slots extends entirely and radially through the expandable disc.

9. The end disc according to claim 7, wherein the shaft-securing device comprises an opposed-tapered lock.

10. The end disc according to claim 7, wherein the expandable disc comprises a metallic material.

11. The end disc according to claim 7, wherein the expandable disc can also comprise a non-metallic material.

12. The end disc according to claim 7, wherein a shaft is inserted through the shaft-securing device, the shaft, the shaft-securing device and the expandable disc are placed inside of a finished or unfinished tube, the securing of the shaft-securing device to the shaft causes the expandable disc to expand and form a frictional seal between the expandable disc and the finished or unfinished tube, and a frictional seal between the expandable disc and the shaft securing device.

13. An end disc comprising,
(a) a generally circular-shaped expandable disc having a plurality of slots; and
(b) a shaft-securing device,
wherein the expandable disc surrounds the shaft-securing device,
wherein the tightening of the shaft-securing device to a shaft causes the expandable disc to expand.

14. The end disc according to claim 13, wherein the expandable disc comprises a metallic material.

15. The end disc according to claim 13, wherein the expandable disc can also comprise a non-metallic material.

16. The end disc according to claim 13, wherein a shaft is inserted through the shaft-securing device, the shaft, the shaft-securing device and the expandable disc are placed inside of a finished or unfinished tube, the tightening of the shaft-securing device to the shaft causes the expandable disc to expand and form a frictional seal between the expandable disc and the tube, and a frictional seal between the expandable disc and the shaft securing device.

17. A end disc comprising,
(a) a generally circular-shaped expandable disc having at least three slots; and
(b) an opposed-tapered lock,
wherein the expandable disc surrounds the opposed-tapered lock,
wherein the tightening of the opposed-tapered lock to a shaft causes the expandable disc to expand.

18. The end disc according to claim 17, wherein the expandable disc comprises a metallic material.

19. The end disc according to claim 17, wherein the expandable disc can also comprise a non-metallic material.

20. The end disc according to claim 17, wherein the expandable disc measures at least 6 millimeters thick.

21. A end disc comprising,
(a) a generally circular-shaped expandable disc measuring at least 6 millimeters thick having at least three slots extending substantially and radially through the expandable disc with at least one of the at least three slots extending entirely and radially through the expandable disc; and
(b) an opposed-tapered lock,
wherein the expandable disc is in contact and surrounds the opposed-tapered lock,
wherein the securing of the opposed-tapered lock to a shaft causes the expandable disc to expand.

22. The end disc according to claim 21, wherein the expandable disc comprises a metallic material.

23. The end disc according to claim 21, wherein the expandable disc can also comprise a non-metallic material.
